(19) United States
(12) Patent Application Publication
(10) Pub. No.: US 2013/0069874 A1
(43) Pub. Date: Mar. 21, 2013

(54) Game-style universal computer controller

(71) Applicants: Boris Kamentser, Fountain Valley, CA (US); Eugenia Kamentser, Fountain Valley, CA (US)

(72) Inventors: Boris Kamentser, Fountain Valley, CA (US); Eugenia Kamentser, Fountain Valley, CA (US)

(73) Assignee: Bokam Engineering, Inc.

(21) Appl. No.: 13/200,174

(22) Filed: Sep. 19, 2011

(51) Int. Cl. G06F 3/033; G09G 5/00

(52) U.S. Cl. 345/161; 345/156

(57) ABSTRACT

A computer controller configured to meet the environmental and physical requirements that are encountered in gaming or by military personnel. The controller provides a display, cursor movement control devices and a plurality of switches, joysticks and the like for responding to display-generated functions such as icons for selecting programs. This embodiment is hard wired to the remaining components of a full computer system. Such components would normally be contained in the same housing or be carried by a user in a backpack or mounted on waistbelts or other body-supported wearables. In another embodiment, an attachable version of the controller is used to transform an existing portable computer such as a tablet or the like. The controller is configured to be attached to the portable computer to provide trigger switches, joysticks, push buttons and the like for a more rugged or gaming configuration.

### BACKGROUND OF THE INVENTION

1. Field of the Invention

The present invention relates generally to the field of computers and more specifically to the field of computer controllers that are especially rugged and adapted for use in remote and harsh environments such as in military applications as well as in gaming.

2. Background Art

Computer equipment for use in the field, especially where it will be used in a military or a gaming environment, must be portable, yet especially rugged, tolerant of motion and rough handling and easily operated by users who may be wearing heavy clothing such as gloves and the like. A conventional computer and ordinary peripheral equipment would be far too delicate and therefore entirely unreliable in such conditions. A conventional laptop or ordinary mouse and keyboard, probably wouldn't last very long in such an environment. The present invention relates to equipment for such special circumstances wherein what is actually held by a user is rugged, lightweight, easily manipulated by gloved hands and easy to see and use under even difficult conditions. Moreover, what is actually held by a user is no more than what is needed to see a display and control a cursor, click on icons, etc. The remaining elements of the computer are either in the same housing or are contained in a backpack, or otherwise strapped to the user's body to avoid adding to the burden of his hands, arms and shoulders which need to be available to other purposes, especially in a combat environment and even in a gaming situation.

### SUMMARY OF THE INVENTION

The present invention comprises a computer controller that is especially configured to meet the unusual environmental and physical requirements that are encountered in gaming or by military personnel in a combat situation. Two different embodiments are disclosed herein. In the first embodiment, the controller provides a display, cursor movement control devices and a plurality of switches, joysticks and the like for responding to display-generated functions such as icons for selecting programs. The first embodiment is configured to be hard wired to the remaining components of a full computer system including memory, hard drive storage, motherboard, communications, and other related peripheral devices such as a printer, WiFi interface and portable power sources. Such components would normally be contained in the same housing or be carried by a user in a backpack or mounted on waistbelts or other body-supported wearables. In this way, the user employs his hands, arms and shoulders to hold the controller, thereby leaving him free to shift the controller to one hand or to a wearable pouch whenever he needs to act quickly to do other things, i.e., shoot a rifle.

In a second embodiment of the invention, an attachable version of the controller is used to transform an existing portable computer such as a tablet or the like. In this version, the controller is configured to be attached to the portable computer to provide trigger switches, joysticks, push buttons and the like for a more rugged or gaming configuration.

A significant feature of the invention's preferred embodiments is at least one spring-biased cantilevered actuator arm in a trigger device along the upper exterior surface of the controller. This arm permits cursor control or “click” switch activation with one finger for ultimate convenience in the field. Both embodiments disclosed herein provide a display which may be ruggedized to withstand the rough handling and harsh environment likely to be encountered in gaming or in military applications.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional view of the front and top of a first embodiment of the invention which is designed primarily to be connected by cable to a separate chassis;

FIG. 2 is an enlarged, partially broken-away view of the spring-biased cantilevered actuator of the embodiment of FIG. 1;

FIG. 3 is a view similar to that of FIG. 2, but showing the actuator being depressed;

FIG. 4 is a view of the FIG. 1 embodiment showing the configuration used to provide a pair of actuators on each end of the controller;

FIGS. 5 and 6 illustrate sectional views of a second actuator taken along lines 5-5 of FIG. 4 and showing two respective modes of activation;

FIG. 7 is a plan view of the interior of the embodiment of FIG. 1 illustrating the wiring interface thereof; and

FIGS. 8-10 are various views of a second embodiment of the invention designed to be mated with a stand-alone computer device.

### DETAILED DESCRIPTION OF PREFERRED EMBODIMENTS

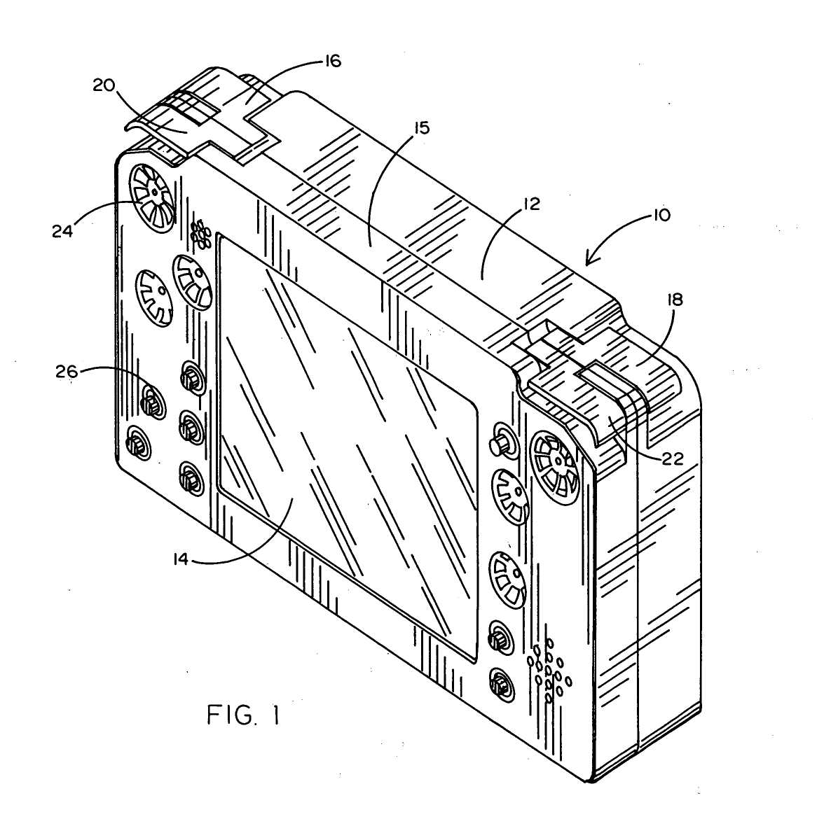

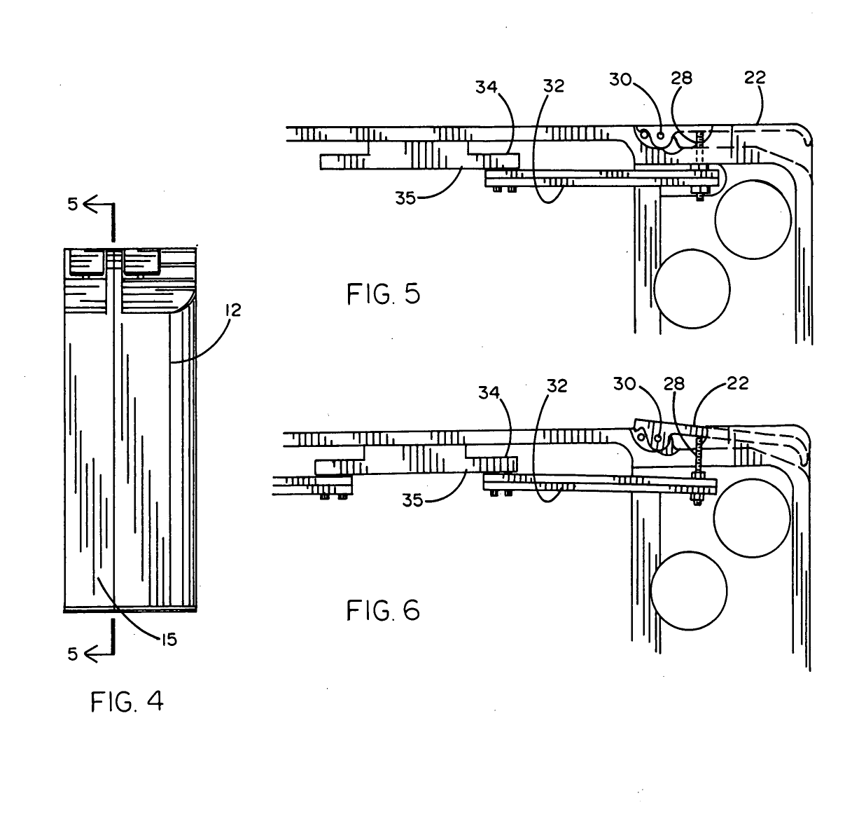

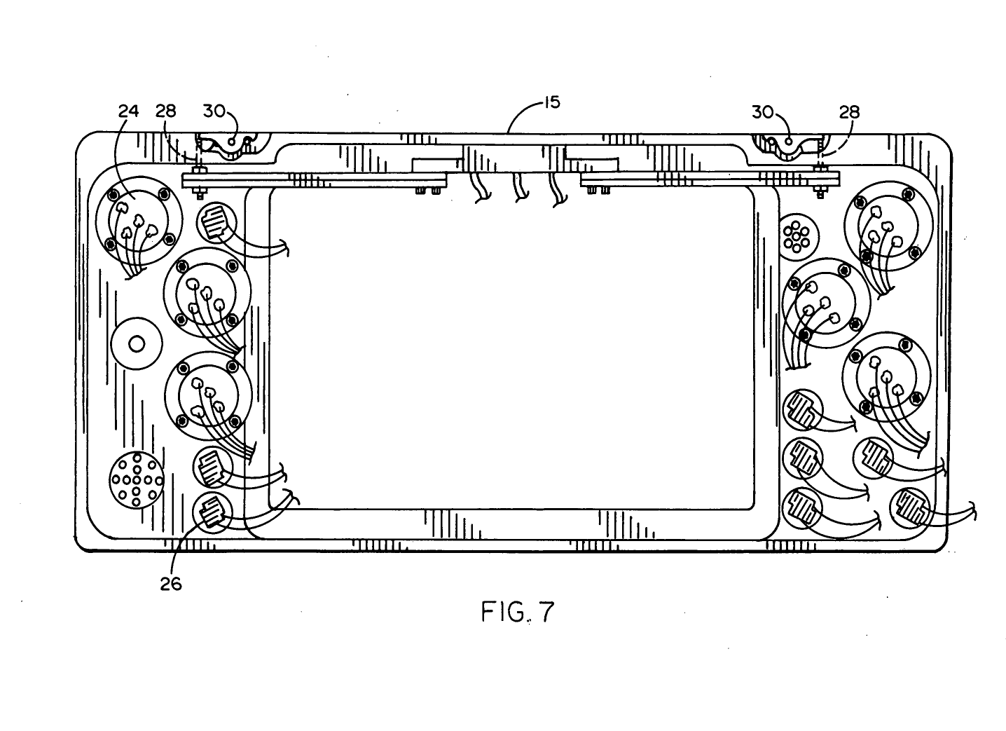

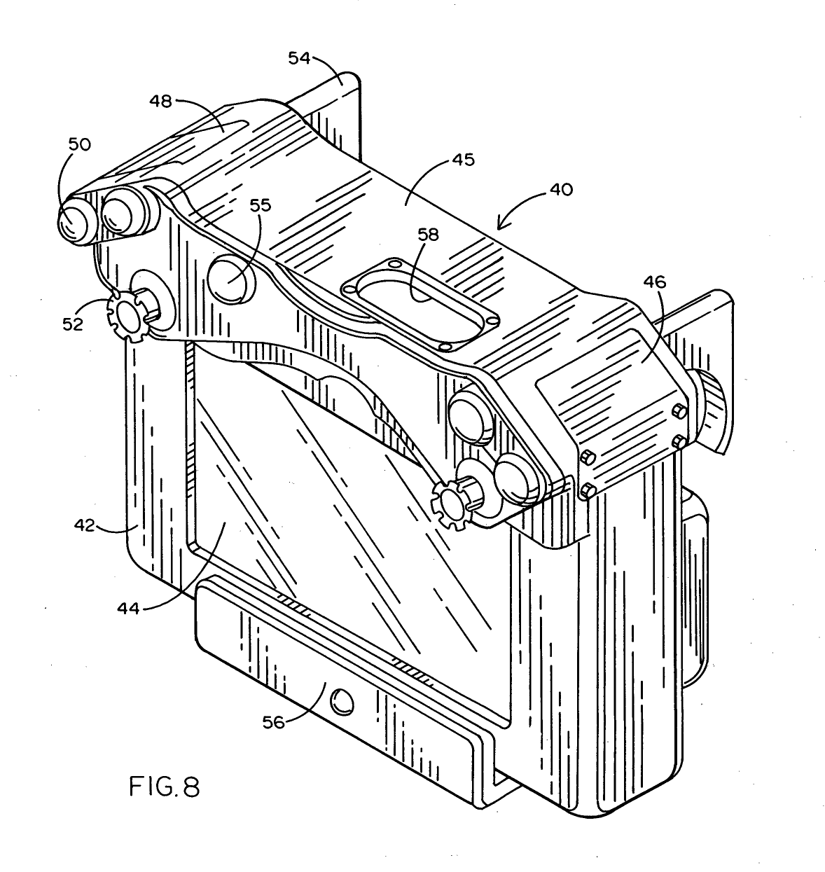

Referring to the accompanying drawings and initially FIGS. 1-7, it will be seen that a first embodiment of a controller 10 comprises rear housing 12, front housing 15 and a computer display screen 14. A plurality of thumb-depressible, triggers 16, 18, 20 and 22 is provided at the top of rear and front housings 12 and 15. These triggers may be programmed to provide mouse-type functions including cursor movement and direction control. In addition, these triggers may be provided with proportional cursor rate control capabilities wherein the extent of depression force applied to the triggers will also control cursor movement rate as will be described hereinafter. A plurality of finger activated joysticks 24 and a plurality of finger-activated push buttons 26 are also provided and can be programmed in a variety of ways to function as mouse-type switches, pointers and the like depending upon the specific gaming or military applications of the invention.

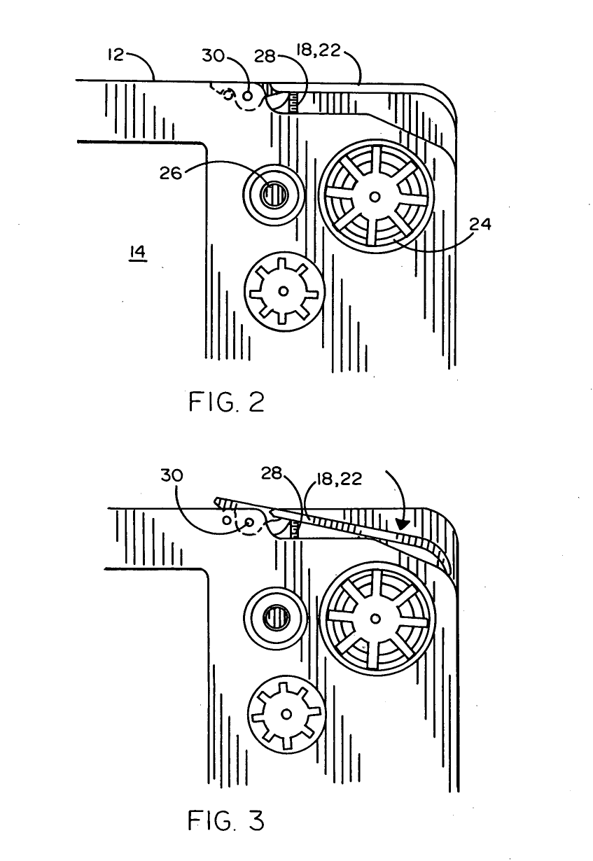

As seen best in FIGS. 2-6, thumb-depressible triggers 16, 18, 20 and 22 each operates as a spring-biased actuator to depress an arm 28 as the actuator is being rotated around a fulcrum 30. The arm's motion then bends an elongated leaf spring 32 to which the arm 28 is connected at one end. Leaf spring 32 is firmly connected at its opposed end to a flange 34 of a sensor surface 35. Surface 35 has a plurality of strain transducers (not shown) which reside on the surface in a bridge configuration, responding to bending of leaf spring 32 by generating a voltage depending on the magnitude of the displacement of arm 28. The various joysticks 24 may be configured to operate in a similar manner based on direction and force applied to each joystick by the user. The operation of the triggers and joysticks using strain transducers which may be configured as electrical bridges, is disclosed in issued U.S. Pat. Nos. 5,835,977 and 5,811,694, the entire contents of which are hereby incorporated herein by reference as if fully set forth herein.

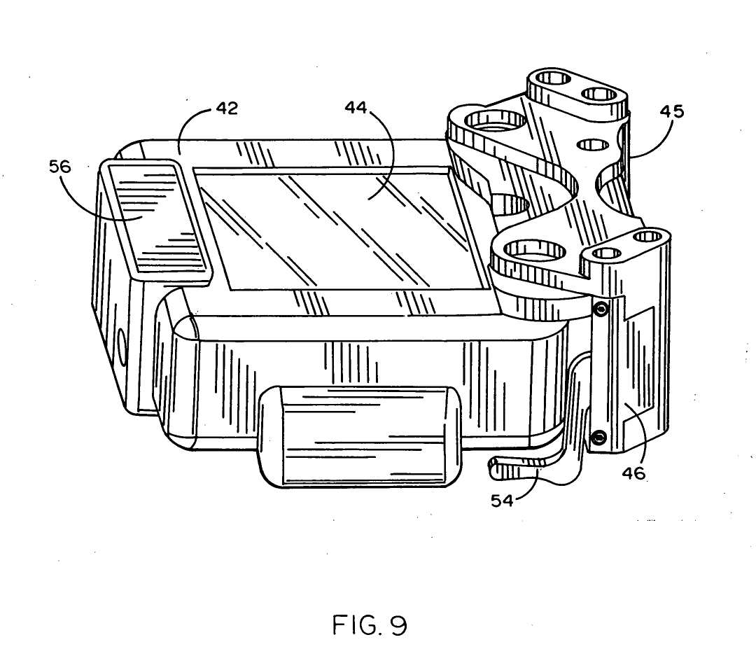

FIG. 7 shows the interior of front housing 15 and the wiring from the various triggers, joysticks and push buttons of controller 10. These various wires would normally be joined into a unitary cable (not shown) which may be connected external of the controller 10 to a separate chassis which may be carried by the user. Alternatively, the controller 10 may have the PCB-mounted memory, hard drive, I/O circuits and drivers, which make it a self-contained computer unit within rear housing 12 and front housing 15 without any external connection. Therefore, the ruggedization and/or gaming functionality of the embodiment shown in FIGS. 1-7 is not limited to either configuration.

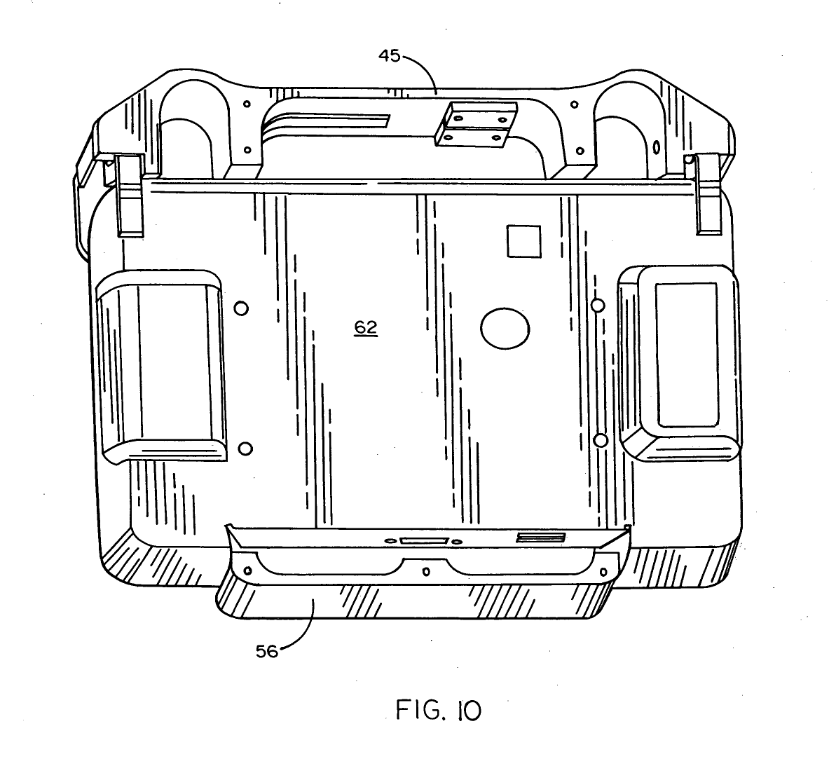

A second embodiment which is especially configured to attach to and work with a portable hand-held computer device (i.e., tablet computer) is shown in FIGS. 8-10. This second embodiment controller 40 attaches to a self-contained, commercially available computer device 42. The computer 42 has its own display 44 and its own standard computer characteristics including at least one USB port or other external interface connector to which the inventive attachment device 45 can be electrically connected to provide more gaming style functionality. To facilitate mechanical attachment to the computer device 42, the second embodiment 40 also comprises a bottom bracket 56 and a back plate 62, both mechanically integral to the overlying controller attachment device 45. The controller attachment device 45 employs a pair of attachment plates 46, 48 having screws to secure it to the computer device 42.

Like the first embodiment 10 of FIGS. 1-7, the second embodiment 40 employs leaf spring-based triggers 54, as well as a plurality of push buttons 50 and 55 and joysticks 52 to provide more gaming oriented finger-based control of cursor functions and other actuators to convert a touch-screen computer device into a more gaming style system. An RF transmissive aperture 58 permits wireless functions (i.e., Bluetooth, GPS, WiFi, etc.) to operate unimpeded by the metal body of controller 45.

It will now be understood that what is disclosed herein comprises a military or game-style computer controller that operates with either a hand-held computer device, or with a separate chassis, or is connected onto a tablet-type computer to convert such devices for finger-type cursor control and other functions that become more rugged and more operable in gaming applications or in a harsh environment. The scope hereof is to be limited only by the appended claims.

We claim:

1. A controller apparatus for operating a computer to which the apparatus is electrically connected; the apparatus comprising:
at least one finger-operated trigger mechanism controlling a cursor on a display screen of said computer, said trigger mechanism depressible for bending a leaf spring connected to a sensor surface having a plurality of sensors connected in an electrical bridge configuration for generating a cursor control voltage depending upon the force applied to said trigger mechanism.

2. The controller apparatus recited in claim 1 wherein said apparatus is in a separate housing and is connected to said computer by a cable.

3. The controller apparatus recited in claim 1 wherein said apparatus is mechanically attached to said computer and is electrically connected via a USB port.

4. The controller apparatus recited in claim 1 wherein said apparatus is contained within said computer in a common unitary housing.

5. The controller apparatus recited in claim 1 further comprising at least one joystick connected to a sensor-based surface having a plurality of sensors arranged in an electrical bridge for generating a computer display control signal in response to a force applied to said joystick.

6. A method for adapting a portable computer to use with finger force-based control; the method comprising the steps of:
a) preparing a controller by configuring a housing for mechanical attachment to said computer;
b) installing in said controller at least one finger actuatable cursor control device employing a strain-transducer bridge for generating a signal in response to a finger force applied to transducers in said bridge; and
c) connecting said controller to said computer both mechanically and electrically for controlling movement of said computer's cursor by applying a finger force to said cursor control device.

7. The method recited in claim 6 wherein said cursor control device comprises a joystick.

8. The method recited in claim 6 wherein said cursor control device comprises a leaf spring trigger.
